(19) United States
(12) Patent Application Publication
(10) Pub. No.: US 2020/0354284 A1
(43) Pub. Date: Nov. 12, 2020

(54) PREPARING ORGANIC FERTILIZER FROM AGRICULTURAL WASTES AND LIVESTOCK MANURE

(71) Applicants: Jingqi Yang, Harbin (CN); Jin Yuan, Harbin (CN)

(72) Inventors: Jingqi Yang, Harbin (CN); Jin Yuan, Harbin (CN)

(21) Appl. No.: 16/671,127

(22) Filed: Oct. 31, 2019

(30) Foreign Application Priority Data
May 6, 2019 (CN) 201910316527.8

(51) Int. Cl. C05F 17/70; C05F 5/00; C05F 3/00

(52) U.S. Cl. CPC C05F 17/70; C05F 3/00; C05F 5/002

(57) ABSTRACT

This invention provides a method of preparing organic fertilizer by combining agricultural wastes and livestock manure, belonging to the technical field of preparing organic fertilizer. 1. Collect agricultural wastes. 2. Crush agricultural wastes to fragments of 1-4 cm in length after removing debris, and make a composting bed, 110-160 kg per cubic meter. 3. Prepare maturing agent: Put water into a plastic container at room temperature for 24 hours, then add maturing agent, such that the mass ratio of water to maturing agent is 1000:5, stir, and leave it 24 hours after stirring. Then spray evenly on the composting bed. 4. After step 3, the water content of the compost is controlled at 55%-65%; the bulk density is controlled at 110˜240 kg/m\hat{ }3; and the proportion of raw materials is treated by slot chelation. 5. livestock manure is sprayed evenly on the composting bed every day, and the sewage of livestock and poultry manure is controlled at less than 85%, and 8˜50 kg of livestock and poultry manure is sprayed on every cubic meter of the composting bed every day. Fermentation 1 to 2 months later.

### CLAIM OF PRIORITY UNDER 35 U.S.C. § 119(A)

The present application for patent claims priority to pending patent application no. 201910316527.8, filed in the China National Intellectual Property Administration on May 6, 2019, and assigned to the assignee hereof and hereby expressly incorporated by reference herein as if fully set forth below and for all applicable purposes.

### TECHNICAL FIELD

This invention relates to a method of preparing organic fertilizer from agricultural wastes and livestock manure, falling into the technical filed of organic fertilizer preparation.

### BACKGROUND

Large farms produce a great amount of agricultural wastes and livestock manure every day. The surrounding environment can be severely polluted if the waste and manure are not dealt with in a timely manner. Straw is a kind of typical agricultural wastes, which has historically been burned on the spot. Recently, in order to clean the atmosphere in China, the burning of straw was banned, resulting great pressure on the areas where more straw is produced. A patent application, whose publication number is CN109265212A, published on Jan. 25, 2019 and named “a method of compost fertilizer from cow dung and straw” discloses a kind of fruit stalk of livestock manure and compost method. In the cited patent application, the livestock manure is added at one time, during which the carbon-nitrogen ratio should be adjusted. Adding high carbon-nitrogen ratio and high carbon accessories, bean dregs, mushroom dregs, tree branches and other materials complicates the composting process and increases the cost of composting.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various representative aspects, the present invention includes a method of preparing organic fertilizer from agricultural wastes and livestock manure, comprising:

Step 1: collecting agricultural wastes;

Step 2: pretreatment: producing a composting mattress which is 110-160 kg per cubic meter by removing impurities from the agricultural wastes and crushing the agricultural wastes into fragments of 1-4 cm in length;

Step 3: preparing decomposition agent solution: adding water into the plastic container at room temperature and standing for 24 hours, adding the decomposing agent with the mass ratio of water to the decomposing agent in 1000:5 by stirring evenly with wood stick and standing for 24 hours, and spraying evenly on the composting mattress and making the initial microbial content of compost more than 200 billion/g;

Steps 4: static fermentation: after step 3, the compost moisture content was controlled at 55%-65% and the bulk density was controlled at 110-240 kg/m; the compost was treated by slot chelation in the height of 1.5 and the width of 1.5-10 m when natural ventilation was applied; after completing the accompanying mattress process, the temperature of the daily chelating fermentation process remained between 45 and 75° C.;

Step 5: evenly spraying livestock manure with the ratio of manure and water less than 85% on the mattress every day and keeping spraying 8-50 kg of livestock manure on every cubic meter of mattress for 1-2 months;

Step 6: after evenly spraying livestock manure every day, dumping the compost one to two times, which was conducive to chelating fermentation, and keeping the oxygen content in the fermentation tank between 5 and 15%;

Step 7: static mineralization: after 25 days of spraying livestock manure, it can be stationary mineralization, keep ventilation smooth and stirring one to two times per day; and

Step 8: screening: after the impurities are removed, the finished organic fertilizer is obtained.

The disclosed method may be utilized in areas where the manure amount is relatively large and the straw output is relatively large, and the manure and a large amount of agricultural wastes can be disposed of in large quantities. The organic fertilizer prepared can improve the problems of soil acid-base imbalance, soil hardening, organic matter absence, trace element absence, etc. The organic fertilizer prepared can also replace a large number of chemical fertilizers, provides strong guarantee to the eco-agriculture and belongs to environmental protection projects of agriculture and aquaculture.

The method of this invention breaks the requirement of traditional C/N ratio index, has positive social benefits for popularizing the preparation of organic fertilizer, timely and large-scale treatment of manure in aquaculture farms, and improvement of environmental conditions.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a flow chart illustrating an exemplary process for preparing organic fertilizer from agricultural wastes according to an aspect of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

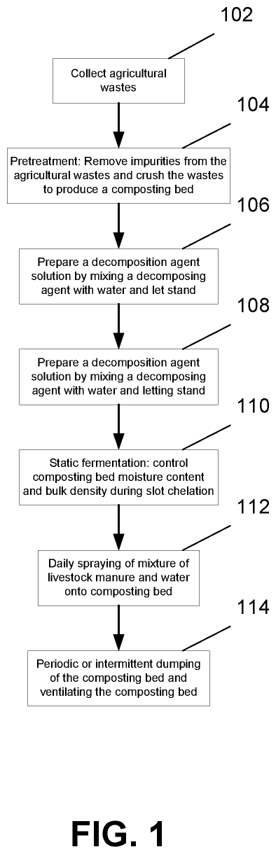

Various aspects of the present disclosure are related to a method of preparing organic fertilizer from agricultural wastes and livestock manure. In an exemplary embodiment, the method includes the following steps. Reference is made to the illustration of FIG. 1 in the following description.

Step 1: at block 102, collecting agricultural wastes. For example, such agricultural wastes may include various waste products including but not limited to straw, crops, rice husks, naturally dried crop straw and/or rice husks, etc.

Step 2: at block 104, pretreatment. A composting bed having a density of, for example, 110-160 kg per cubic meter is produced by removing impurities from, and suitably processing the agricultural wastes. For example, processing the agricultural wastes may include crushing the agricultural wastes into fragments of about 1-4 cm in length.

Step 3: at block 106, preparing decomposition agent solution. Water having a suitable temperature (e.g., room temperature) is added into a suitable container (e.g., a plastic container). In some examples, this water may be left to stand for a suitable time (e.g., 24 hours). A decomposing agent is added to the water, to obtain a mass ratio of water to the decomposing agent of about 1000:5 by stirring and standing for a suitable time (e.g., about 24 hours). The mixed decomposition agent solution is then applied (e.g., evenly sprayed) on the composting bed such that the initial microbial content of the compost is suitably established (e.g., more than 200 billion/g). In some examples, the maturifier is a marketable product, whose name may include: Maturifier, Organic Material Maturity, Biological Bacteria Agent, Biological Fermentation Agent; Acting on Crop Straw, Livestock and Poultry Feces, Domestic Waste and Municipal Sludge.

Step 4: at block 108, static fermentation. After step 3, the moisture content of the composting bed may be controlled at a suitable moisture level (e.g., about 55%-65%). Further, the bulk density of the composting bed may be controlled at about 110-240 kg/m\hat{ }3. The composting bed may be treated by slot chelation in the height of 1.5 m and the width of about 1.5-10 m when natural ventilation is applied. After completing the accompanying composting bed process, the temperature of the daily chelating fermentation process may be maintained between about 45 and 75° C. The process of continuous high temperature is a harmless process of fermentation. The fermentation process may continue for 1 to 2 months at about 45-75° C., and pathogens, eggs and grass seeds can be killed.

Step 5: at block 110, the composting bed may periodically or intermittently be evenly sprayed (e.g., once a day) with a mixture of livestock manure and water having a ratio of less than about 85%. Livestock manure may include manure from any livestock, such as cattle, poultry, pigs, horses, goats, sheep, etc. The amount of the livestock manure sprayed each day may be about 8-50 kg on every cubic meter of the composting bed. This spraying process may continue for about 1-2 months. In order to ensure secondary pollution control in transportation, and moisture control in the pretreatment of tank fermentation, other obvious impurities should not be mixed.

Step 6: at block 112, after evenly spraying livestock manure every day, dumping the compost one to two times. This is conducive to chelating fermentation, and keeps the oxygen content in the fermentation tank between about 5-15%. Various modes of ventilation of the compost may be utilized within the scope of this disclosure, including but not limited to the following three exemplary modes of ventilation: 1. Natural diffusion of air from the compost surface diffuses oxygen naturally into the compost interior to achieve the purpose of feeding; 2. Turn-over and agitation diffuse oxygen to the porous surface of solid particles through gap-type turning and agitation to achieve the purpose of oxygen supply; 3. Forced ventilation achieves the purpose of oxygen supply through forced ventilation in the gap of pipeline at the bottom of the compost.

Step 7: static mineralization. After about 25 days of spraying livestock manure onto the composting bed, to provide for static mineralization, keep ventilation smooth and stir periodically or intermittently (e.g., one to two times per day).

Step 8: screening. After removing impurities from the composting bed, the finished organic fertilizer is obtained.

The technical specifications of the organic fertilizer prepared by the above-mentioned embodiments have been tested and meet the requirements of Table 1.

TABLE 1

| | INDI- |
|---|---|
| ITEMS | CATORS |
| The mass fraction of organic matter (in terms of drying basis) | ≥45% |
| The mass fraction of total nutrients (N + P_2O_5 + K_2O)/ | ≥5% |
| (%) in terms of drying basis) | |
| The mass fraction of water (fresh sample) | 30% |
| Acidity (pH) | 5.5-8.5 |

The limits of heavy metals in organic fertilizers met the requirements of Table 2.

TABLE 2

| | INDI- | |
|---|---|---|
| ITEMS | CATORS | |
| Total arsenic (As) (based on drying) | ≤15 | mg/kg |
| Total mercury (Hg) (based on drying) | ≤2 | mg/kg |
| Total Lead (Pb) (Based on Drying) | ≤50 | mg/kg |
| Total cadmium (Cd) (based on drying) | ≤3 | mg/kg |
| Total chromium (Cr) (based on drying) | ≤150 | mg/kg |

The mortality rate of Ascaris eggs and the number of fecal coliform bacteria accorded with the requirement of NY884.

The number of fecal coliform bacteria is less than 100 per g, and the mortality rate of Ascaris eggs was more than 95%.

As mentioned above, only some specific embodiments of the present invention are disclosed, based on selected implementations under the overall conception of the present invention, and the scope of protection of the present invention is not limited thereto. Any change or substitution that can easily be thought of by any technician familiar with the technical field of the present invention within the scope of the disclosed technology of the present invention should cover the protection paradigm of the present invention. Therefore, the scope of protection of the present invention should be based on the scope of protection of the claims.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of preparing organic fertilizer from agricultural wastes and livestock manure, comprising:
step 1: collecting agricultural wastes;
step 2: pretreatment: producing a composting bed having a density of about 110-160 kg per cubic meter by removing impurities from the agricultural wastes and crushing the agricultural wastes into fragments of about 1-4 cm in length;
step 3: preparing decomposition agent solution: adding water into the plastic container at room temperature and standing for about 24 hours, adding the decomposing agent with the mass ratio of water to the decomposing agent of about 1000:5 by stirring and standing for about 24 hours, and spraying on the composting bed;
step 4: static fermentation: after step 3, controlling the composting bed moisture content at about 55%-65%, and controlling the composting bed bulk density at about 110-240 kg per cubic meter; treating the composting bed by slot chelation in a height of about 1.5 m and a width of about 1.5-10 m when natural ventilation is applied and making the initial microbial content of compost more than 200 billion/g;
step 5: spraying livestock manure with a ratio of manure and water less than about 85% on the composting bed every day, and spraying about 8-50 kg of livestock manure on every cubic meter of the composting bed for about 1-2 months;
step 6: dumping the composting bed one to two times, and keeping an oxygen content in the fermentation tank between about 5-15%;
step 7: static mineralization: after about 25 days of spraying livestock manure, stirring the composting bed about one to two times per day; and
step 8: screening: after removing impurities from the composting bed, obtaining a finished organic fertilizer.

2. The method of claim 1, wherein the agricultural wastes include one or more of crop straw or rice husks.

3. The method of claim 1, wherein the keeping the oxygen content in step 6 comprises at least one of:
natural diffusion of air from the compost surface diffuses oxygen naturally into the compost interior to achieve the purpose of feeding;
turn-over and agitation diffuse oxygen to the porous surface of solid particles through gap-type turning and agitation to achieve the purpose of oxygen supply;
forced ventilation achieves the purpose of oxygen supply through forced ventilation in the gap of pipeline at the bottom of the compost; or some combination thereof.

4. A method of preparing fertilizer from agriculture wastes and manure, the method comprising:
applying a decomposition agent to a composting bed of agriculture wastes;
fermenting the composting bed during a fermenting period having a duration of about 1-2 months;
during the fermenting period, periodically applying a mixture of water and manure to the composting bed, and periodically dumping the composting bed; and
ventilating the composting bed and periodically stirring the composting bed for static mineralization.
